(19) United States
(12) Patent Application Publication
(10) Pub. No.: US 2011/0072514 A1
(43) Pub. Date: Mar. 24, 2011

(54) Scan Engine Manager with Updates

(75) Inventors: Ari Gilder, New York, NY (US); Robert Herbst, Stony Brook, NY (US); Shrey Shah, Hicksville, NY (US)

(73) Assignee: MICROSOFT CORPORATION, Redmond, WA (US)

(21) Appl. No.: 12/613,569

(22) Filed: Nov. 6, 2009

Related U.S. Application Data
(60) Provisional application No. 61/245,271, filed on Sep. 23, 2009.

(51) Int. Cl. G06F 11/00

(52) U.S. Cl. 726/22

(57) ABSTRACT

A scan management system may configure various workloads and data streams within those workloads to be directed to various scan engines. The scan management system may be updatable and configurable by receiving a catalog of available scan engines and configuring the workloads and scan engines according to a policy that may be locally created and managed. The scan management system may be capable of reconfiguring the scan engines, including upgrading, adding, deprecating, and changing scan engines while being fully operational. In some cases, a single data stream may be scanned by two or more different scan engines, and a single scan engine may be used to scan two or more different data streams.

### BACKGROUND

Scan engines are services that may scan a data stream for particular content. A common example is an antivirus scan engine that may scan an email message for viruses, which may be embedded or hidden applications that may do damage to a computer system.

Many different types of scan engines exist and many different suppliers compete to provide scan engines and scan engine services to consumer and corporate computer systems. The scan engines may be run against various data streams that may be produced by computer workloads. In the example above, the workload may be a messaging system and the data stream may be individual email messages.

As the threats to computer systems change, different scan engines or upgraded versions of scan engines may be created.

### SUMMARY

A scan management system may configure various workloads and data streams within those workloads to be directed to various scan engines. The scan management system may be updatable and configurable by receiving a catalog of available scan engines and configuring the workloads and scan engines according to a policy that may be locally created and managed. The scan management system may be capable of reconfiguring the scan engines, including upgrading, adding, deprecating, and changing scan engines while being fully operational. In some cases, a single data stream may be scanned by two or more different scan engines, and a single scan engine may be used to scan two or more different data streams.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with a configurable scanning system.

FIG. 2 is a diagram illustration of an embodiment showing an architecture for a configuration scanning system.

FIG. 3 is a flowchart illustration of an embodiment showing a method for preparing new scan engines.

FIG. 4 is a flowchart illustration of an embodiment showing a method for managing scan engines.

FIG. 5 is a timeline illustration of an embodiment showing a side by side switchover between scan engines.

FIG. 6 is a timeline illustration of an embodiment showing a sequential switchover between scan engines.

### DETAILED DESCRIPTION

A scan management system may be configurable to change scan engines and scanning configuration for various workloads. The scan management system may be updated periodically with a new catalog of available scan engines, and the scan management system may configure itself in accordance with a policy definition to configure the scan engines.

The scan engines may scan the content of a data stream for specific content, such as viruses or malicious code. The data streams may be associated with a workload, such as an email or messaging distribution system. The scan management may configure the data streams to be directed to the appropriate scan engine with the proper settings to achieve the goals of the policy.

In a typical use scenario, a server or other computer may have multiple workloads that may be scanned using scan engines such as antivirus or other content scanning mechanisms. The scan management system may allow a locally defined policy to be implemented so that the desired level of protection is achieved using the available scan engines.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

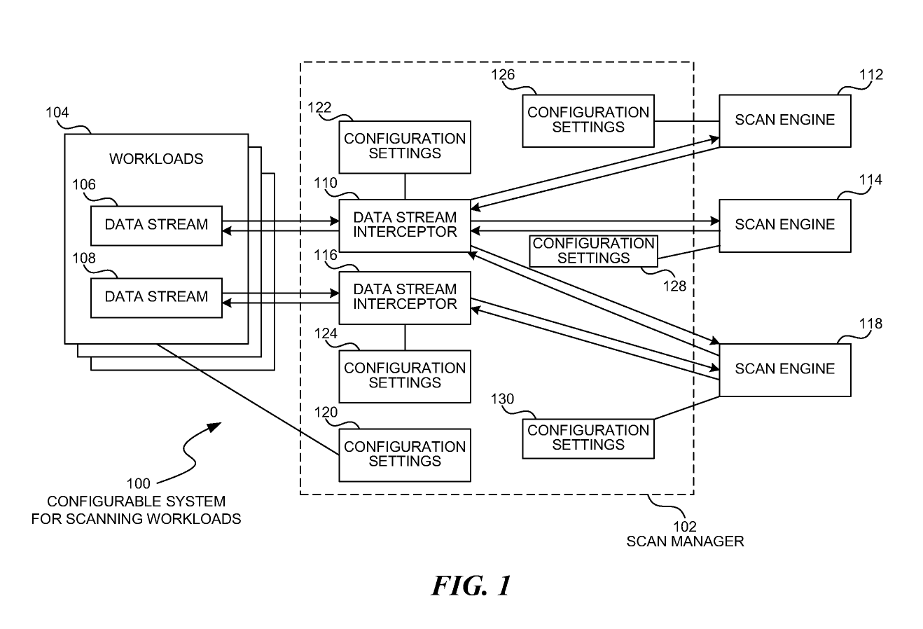

FIG. 1 is a diagram of an embodiment 100 showing a system with a scan management system. Embodiment 100 is a simplified example of a scan management system that may be capable of being reconfigured using a catalog and a policy definition.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 illustrates one contextual example of how a scan management system may operate. One of a set of workloads 104 may contain data streams 106 and 108. The scan manager 102 may use data stream interceptors 110 and 116 to direct the contents of the data streams to one or more scan engines 112, 114, and 118.

The scan manager 102 may coordinate and facilitate communications between a workload and its data streams with an appropriate set of scan engines. In some cases, two or more scan engines may be used on a single data stream, such as scan engines 112, 114, and 118 configured to process the data stream 106. In some cases, a single scan engine may process data from two or more data streams, as exemplified by scan engine 118 being configured to process data streams 106 and 108.

The scan manager 102 may be configurable to change the scan engines for a particular workload. For example, a new scan engine or an upgrade to an existing scan engine may become available. The available scan engines may be published in a catalog that may include various metadata concerning each scan engine. A locally defined policy may be used to select the scan engines and configure the scan engines to process specific workloads. The scan manager 102 may configure the workloads, data streams, data stream interceptors, and scan engines to accomplish the desired policy.

The workloads 104 may be any type of workload performed by a computer. In the case of a server computer, the workload may be an email system that receives, processes, and transmits email. Another workload may be a file management system that stores various computer files and makes them available to users across a network. Still another workload may be a gateway application that monitors incoming and outgoing communications between a local area network and a wide area network.

The workloads 104 may be any function that generates or processes a data stream 106. A data stream may be any data that can be analyzed by a scan engine. In some cases, the data streams may be continuous streams of data that may be scanned in real time.

In other cases, the data streams may be segmented or packetized data. An example of segmented data may be data streams that comprise packets of information that may be transmitted over a network, such as packets that are transmitted over Ethernet or other packetized network. In some cases, the individual packets of data may be scanned by a scan engine. In other cases, packets may be arranged together and scanned as a group. Such an example may be receiving packets of data and arranging the packets to form an email message, file, instant message, or other entity that is scanned as a whole. In some such cases, the packets may be assembled together into blocks of data that may be scanned, where the blocks of data are subsets of the entire file, email message, or other entity.

Examples of workloads include workloads that process messages. These may include email services that transport email messages and their attachments, and provide mailboxes and other storage. In some cases, such a workload may be a server that provides the mailboxes and transport, or may be a client that accesses the mailbox and other services provided by the server. Another example may be a workload on a gateway device that connects two networks together. Such a workload may scan incoming and outgoing messages. Other examples of message processing workloads may be text based instant messaging services, voice messaging services, and other messaging services.

Another example of a workload may be a file management system or directory. Such a workload may be found on a server that stores files used by client devices over a network, for example. Other examples may be found on a device that has a file management system for use by applications executing on the device.

In some cases, the workloads may process files or other data. For example, a file conversion application may identify one or more files to convert to a different format, where the data stream may be the files that are processed by the application. In another example, an application may perform queries to a database to store and retrieve data. Each query and response to the database may be a data stream that may be analyzed by a scan engine.

Another example of a workload may be a keystroke logger or other monitoring software. Such a workload may monitor a user's actions on a device, and generate a data stream that may be passed to a scan engine for analysis.

Still another example of a workload may be a web browser that may interact with websites across the Internet. A web browser may be used to download content which may include static content and active content, where the active content may be scripts, applications, and other code that are executable on a client device. The data stream from the workload may include all of the data transmitted and received by the client device.

In some workloads, two or more data streams may be created. In some such cases, the data streams may be organized into different types of data. In the example of an email processing service, one data stream may contain email messages while another data streams may contain email attachments of different types. For example, spreadsheet attachments may be separated into a specific data stream while audio clips may be separated into a different data stream.

In another example, separate data streams may be defined by user or device. In the example of an email processing service, a data stream may be created for each user or groups of users, types of devices receiving or sending the messages, or some other segmentation.

The examples of workloads are merely examples and not meant to be exhaustive.

The scan engines may scan data streams for many different purposes. In general, a scan engine may perform some sort of analysis on a data stream. Many scan engines may be suited to analyze the contents of a data stream, but other scan engines may analyze metadata or other non-content information within the data stream.

One example may be a scan engine that examines a data stream for malicious software such as viruses, worms, Trojan horses, spyware, adware, or other malware. Such scan engines may be used to scan data streams where such malicious software may exist, which may be any data stream that may include messages, files, or other entities that may contain executable code. Such data streams may be found in message handling applications, file handling applications, firewall applications, collaborative worksite systems, databases, webservers, web browser clients, just to name a few.

Another example may be a scan engine that analyzes a data stream for particular content. For example, a scan engine may analyze web browser content for illicit or undesirable information, such as pornography, inappropriate language, phishing threats, unwanted advertising, or other undesirable content. Another example may be a scan engine that searches for a company's trade secret information or information that may be classified or restricted. Such a scan engine may search content for specific keywords, phrases, or other references to restricted information.

In many cases, a scan engine may be tailored or tuned for specific functions. Some scan engines may be highly optimized to scan a specific type of data within a data stream, such as word processing documents or spreadsheet file. Some scan engines may address specific types of content, such as pornography, but may have much less effectiveness in scanning other types of content.

Some scan engines may be suited to analyze many different types of content and many different factors within the content. In some cases, such scan engines may be specifically designed for a type of workload, such as email, that may have many different types of content and many different factors to analyze.

Scan engines may be categorized as active or passive. Active scan engines may analyze a data stream and cause some action to take place in response to the data stream. The action may be performed on every analysis, such as marking an email or file as being scanned. In some embodiments, a scan engine may take action when certain conditions are met, such as flagging a suspicious file as dangerous, quarantining a problem email, or deleting a transmission that is considered inappropriate. In some cases, the scan engine may communicate with the workload to transmit information about the scanned data.

A passive scan engine may collect information about the data being scanned and may not perform specific operations on the data. Such a scan engine may monitor network traffic, for example, which may be used for billing purposes, load balancing, operational statistics, or other functions.

The scan manager 102 may be capable of configuring the scan engines 112, 114, and 116 to perform scanning services for the various data streams 106 and 108. The scan manager 102 may be able to configure the workloads with some configuration settings 120. The configuration settings 120 may include metadata, addresses, routing information, or other information that may be used by the workload 104 to configure the data streams 106 and 108 to be used by the scan manager 102. The configuration settings 120 may change the functions of the workload 104, provide settings or addresses for communicating with a scan engine, or other settings that may cause the workload to operate in a desired manner or interface with a scan engine.

The scan manager 102 may use data stream interceptors 110 and 116 to capture and transmit the data streams 106 and 108 to the appropriate scan engines 112, 114, and 118. The data stream interceptors 110 and 116 may act as an interface between a data stream and a scan engine. In some embodiments, the data stream interceptors 110 and 116 may be active executable code that intercepts a data stream and redirects the data stream to a scan engine. Examples may be a monitoring service that captures information transmitted over a transport, network, data link, or physical layer of an Open System Interconnection Reference Model (OSI) stack.

In some embodiments, the data stream interceptors 110 and 116 may be interfaces that operate at the session layer, presentation layer, or application layer of an OSI stack.

Active data stream interceptors 110 and 116 may perform various interfacing tasks between a data stream and a scan engine, such as translating, reformatting, sequencing, aggregating, separating, or other functions to facilitate the communication.

Active data stream interceptors 110 and 116 may also perform a first level analysis of a data stream and may route portions of a data stream to one scan engine or another. For example, an active data stream interceptor may monitor a data stream that contains files and route specific types of files to one scan engine while other types of files are routed to another scan engine.

In some embodiments, the data stream interceptor 110 and 116 may be a function provided by either a workload or a scan engine and may not be a separate program or executable. In some such embodiments, the data stream interceptor may have an application programming interface (API) that connects a scan engine to a workload. In such cases, the configuration settings 122 and 124 for the scan engines 110 and 116, respectively, may include settings or options used by the application programming interfaces.

When the data stream interceptors are embodied in a workload, the workload may be configured to connect to a scan engine to send the data stream to the scan engine. When the data stream interceptors are embodied in a scan engine, the scan engine may be configured to connect to the workload to receive the data stream from the workload.

In many cases, the scan manager 102 may include configuration settings 126, 128, and 130 for the respective scan engines 112, 114, and 118. These configuration settings may be any settings that can change the operation of the scan engine as well as settings that allow the scan engine to connect to a data stream.

The scan manager 102 is illustrated as a group that contains the various configuration settings as well as the data stream interceptors. In some embodiments, the scan manager 102 may be embodied as a single application that includes all of these functions. In other embodiments, the scan manager 102 may be dispersed across different files, applications, and even computer systems, but the elements of the scan manager 102 may operate together to connect workloads and their data streams to scan engines.

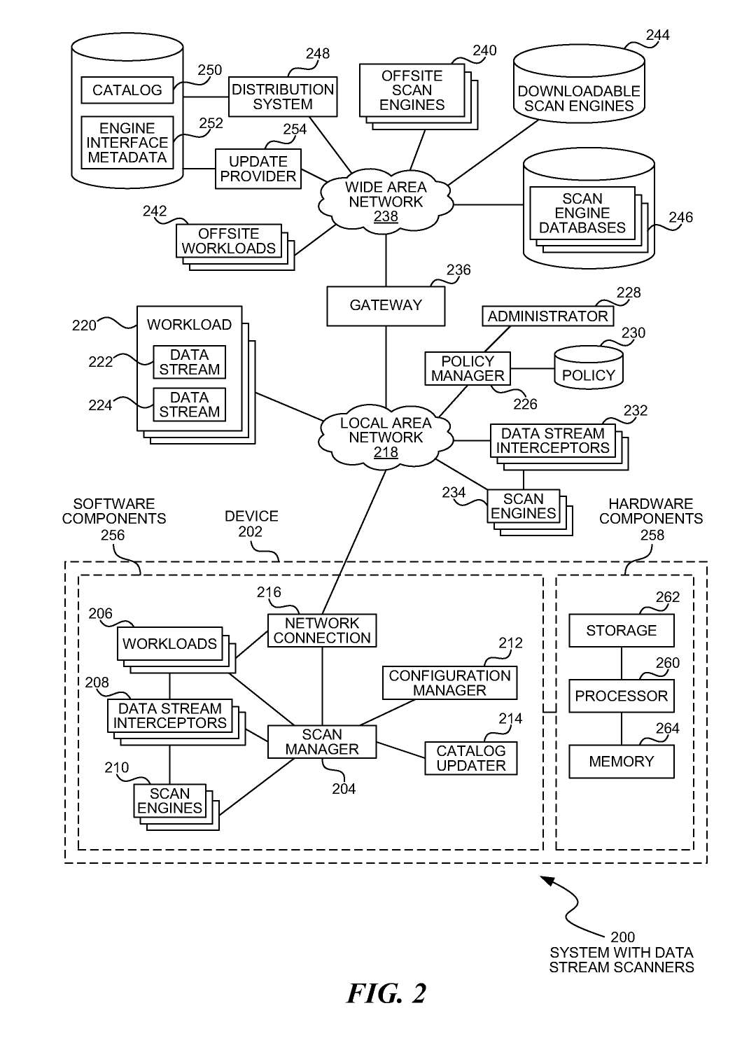

FIG. 2 is a diagram of an embodiment 200 showing a network architecture with a scan management system. Embodiment 200 is a simplified example of one implementation of a scan management system that may be capable of being reconfigured using a catalog and a policy definition.

The diagram of FIG. 2 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a network architecture where different elements of a scan management system may be implemented. In some embodiments, the functions of a scan management system may reside on a single computer system. In other embodiments, some portions of the scan management system may reside on other devices and may be accessed across a local area network or a wide area network.

Device 202 is an example of an embodiment where a scan management system may be contained in a single device. Device 202 is illustrated as having software components 256 and hardware components 258, and may be representative of a conventional computing device such as a server or personal computer, but may also represent any device that has such components, which may include network appliances, routers, gateways, switches, mobile devices, cellular telephones, personal digital assistants, and other devices.

The hardware components 258 may include a processor 260, random access memory 264, and long term storage 262. Many devices may also include user interface devices and other peripherals.

The software components 256 may include a scan manager 204. The scan manager 204 may be the central application or function that configures scan engines to process various data streams within workloads.

In many cases, the scan manager 204 may be capable of switching a data stream from one scan engine to another while continuing to operate. Embodiments 500 and 600 presented later in this specification are examples of two different methods by which a scan manager 204 may be able to change from one scan engine to another.

The scan manager 204 may provide configuration settings for workloads 206, data stream interceptors 208, and scan engines 210. The configuration settings may cause the various components to connect to each other and to operate in a desired manner. Each component may have different settings that may cause different results, and the scan manager 204 may implement a configuration defined by a configuration manager 212 to achieve a specific operational goal.

The configuration manager 212 may receive a catalog of available scan engines and determine configuration settings based on a policy. In a typical embodiment, a catalog may include all available scan engines and various settings and configurations of those scan engines. A catalog updater 214 may receive catalogs on a periodic basis and determine any changes between an old version and a new version of the catalog. Based on those changes, the configuration manager 212 may determine the appropriate configuration which may be implemented by the scan manager 204. Examples of such processes may be found in embodiments 300 and 400 later in this specification.

The software components 256 illustrate an embodiment where a scan manager 204 and the various workloads and scan engines are contained within a single device 202. Such an implementation may be used in server computers, laptop or desktop computers, and even cellular telephones or other computer devices.

Other embodiments may have one or more components located outside the device 202 and available across a local area network 218 or even a wide area network 238.

For example, some embodiments may have workloads 220 with data streams 222 and 224 located across a local area network 218. In one such an embodiment, the scan manager 204 may communicate with the workload 220 to configure the data streams 222 and 224 to be scanned by the local scan engines 210. In another such embodiment, the scan manger 204 may configure the workload 220 and the data stream interceptors 232 and scan engines 234 to communicate with each other. In still another embodiment, the scan manager 204 may configure a local workload 206 to communicate with the scan engines 234 available across the local area network 218.

In some embodiments, the data stream interceptors 232 may be standalone applications or devices that may facilitate communication between the various workloads and scan engines.

In another example, the scan manager 204 may configure the workloads 206 or 220 to be scanned by offsite scan engines 240. In still another example, the scan manager 204 may configure offsite workloads 242 to be scanned by offsite scan engines 240 or local scan engines 234 or 210.

The configuration manager 212 may use a policy 230 that may be defined locally. The policy 230 may be created by an administrator 238 using a policy manager 226. The policy manager 226 may be an application operable on a device that defines a policy that may be implemented by the scan manager 204.

The policy 230 may be an organizational definition of how scanning is to be implemented. The policy 230 may be defined in many different manners and may have different elements within the policy that vary from one embodiment to another.

The policy 230 may define certain types of workloads or certain types of data streams and the desired level of scanning. For example, a company may have a scanning policy that places few restrictions on pornographic material but severe restrictions on spyware and viruses. The company's policy may be configured in such a manner because the company may deal in apparel and many apparel related photos or websites may be considered pornographic by very restrictive scan engines.

In another example, a company's policy may place severe restrictions on communications with computers along a production line in a factory environment and less severe restrictions on computers within an office environment.

In yet another example, a person may define a very restrictive scan level for pornographic, drug related, or other nefarious content when configuring a scan policy for a home environment where children may have access to the Internet.

The policy 230 may define a desired security level for a device or group of devices. The security level may include various factors that concern an administrator that creates the policy and the factors may change from situation to situation. For example, some networks may be concerned with malware and may define a security policy that is very restrictive on allowing executable content inside a network. Other networks may be concerned with outbound transmission of classified content such as trade secret or national security content as part of the security level.

In some embodiments, different levels of security may be applied to different devices. For example, server computers and computers with sensitive information may have a high level of security applied, but laptop computers that have no connection to sensitive information may have a low level of security applied.

The configuration manager 212 may use a catalog of scan engines to determine which scan engines to scan which data streams according to the policy 230. The configuration manager 212 may also determine the appropriate settings for workloads, data stream interceptors, and scan engines to meet the goals of the policy 230.

The scan manager 204 may have a catalog updater 214 that may receive an updated catalog from a distribution system 248 over a connection to a wide area network 238. The distribution system 248 may distribute catalogs and other metadata about the scan engines in various manners. For example, some distribution systems 248 may push updates to various catalog updaters 214 when updates are available or on a predefined schedule. In another example, the distribution system 248 may be configured to respond to a request by the catalog updater 214 for an update. In such an example, the catalog updater 214 may periodically request an update on a predefined schedule or in response to an event, such as an update to the policy 230.

The catalog 250 and other scan engine interface metadata 252 may be modified by an update provider 254. The update provider 254 may be a service provided by the scan engine manufacturer or third party, and may serve as a central registration point for various scan engine vendors or suppliers.

The catalog 250 may include descriptions of various scan engines. In many embodiments, the scan engines may have a status, such as “active” meaning that the scan engine is supported and available for use, “deprecated” meaning that the scan engine is being phased out and that support may soon end, and “obsolete” meaning that the scan engine is no longer supported or available.

The catalog 250 may include descriptions of scan engines that are available for specific workloads. For example, a specific email system may have several scan engines that may operate with the workloads produced by the email system. Such a definition may be different for different vendor's email systems and different versions of those email systems. In another example, a generically defined web browsing workload may have a selection of scan engines that may be applicable. Such a definition may be used by any application that performs web browsing regardless of the browser model or manufacturer.

The engine interface metadata 252 may contain detailed information about each scan engine. The information may include information that may be used by the scan manager 204 to configure the workload, data stream interceptors, and scan engine, as well as how the particular scan engine may receive updates and how the scan engine may be installed and removed.

The engine interface metadata 252 may also include information regarding installation of a scan engine. In many cases, a scan engine may be downloaded from a database 244 and installed. In other cases, the scan engine may be a remotely located scan engine 240 that may be configured and managed by a third party.

In many embodiments, a scan engine may receive periodic updates or changes. In some cases, a scan engine may be updated multiple times throughout a day to respond to various threats that may change quickly. The scan engine interface metadata 252 may include information that enables the scan engine or the scan manager 204 to facilitate receiving scan engine databases 246 from a remote location.

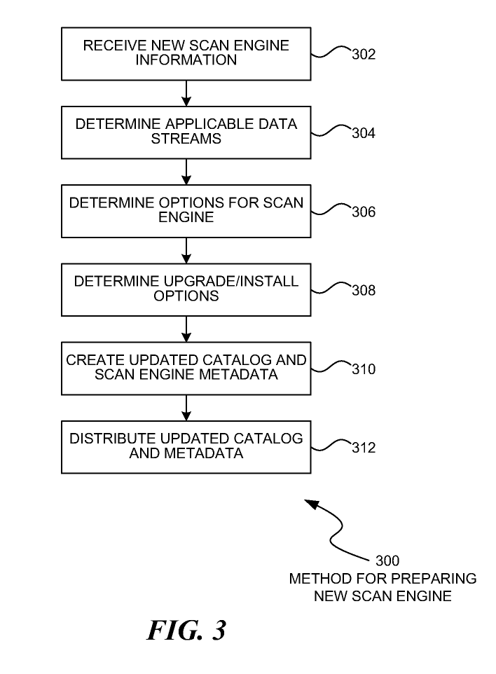

FIG. 3 is a flowchart illustration of an embodiment 300 showing a method for preparing a new scan engine. Embodiment 300 is a method that may be performed by an update provider 254 as described in embodiment 200.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 is a method by which a new or updated scan engine may be prepared for distribution. The process identifies how the scan engine may be used as well as how it may be integrated into existing systems for scanning workloads. The information is added to a catalog of scan engines and distributed to scan managers.

The process of embodiment 300 may be a manual process, but in many embodiments, the process may be fully automated. A schema or other data definition may be used by a scan engine supplier to define various parameters and metadata about the scan engine, and an update provider may automatically receive the scan engine metadata and perform the functions of embodiment 300 to distribute scan engines to various clients.

In block 302, information regarding the new or updated scan engine may be received. The information may be from a scan engine supplier or manufacturer and may include the types of scanning provided by the scan engine and various options for the scan engine's use.

Many scan engines may be used in different capacities and with different options. For example, many scan engines may have sensitivity settings or categories of scanning that may be tailored to certain types of uses. In an example, a web content scanning system may have different settings for home use or workplace use, and may have different levels of sensitivity for each use scenario.

In block 304, the applicable data streams may be determined for the scan engine. Some scan engines are general in nature and may be capable of scanning many different types of data streams, while other scan engines may be more specialized. For example, a general text scan engine may be capable of scanning text based content for specific phrases or other content and would be applicable to any data stream that contains text. In another example, a messaging scanning system may be directed at scanning message metadata to identify messages that are transmitted improperly, such as spoofed addresses, messages sent from known spam senders, and other mechanisms for identifying potentially dangerous or unwanted messages. Such a scanning system may be appropriate for specific types of message related data streams.

The applicable data streams in block 304 may be defined by data stream type. The type may be used by a data stream manager to identify specific instances of data streams within the local system that fit the type.

The type defined in block 304 may define, for example, the type of content scanned, such as text, images, audio, video, or message format, and may further be defined into specific types of each category. In some cases, the type defined in block 304 may relate to specific types of workloads, such as messaging workloads, file transfer workloads, web browser workloads, and others.

In block 306, the options for the scan engine may be defined. The options in block 306 may include the specific options that are used to configure the scan engine to operate inside the scan manager environment, as well as options that may be set by a scan manager to configure the scan engine to operate in different manners when the scan engine is deployed.

The upgrade/install options of block 308 may define how the scan engine may install or upgrade the scan engines. Because of the wide variety of potential scan engines and their upgrade mechanisms, a scan manager may be capable of upgrading in different manners. Examples of two different upgrade paths are illustrated in embodiments 500 and 600. The selection of which method to use for upgrade, as well as any options for such upgrade, may be defined in block 308.

In many embodiments, the upgrade/install options of block 308 may include a Uniform Resource Locator (URL) or other address of a location from which the scan engine may be downloaded and installed. In cases where the scan engine operates remotely, the options may include a URL or address of a server that may perform the scan operation.

Once the various upgrade options, usage options, and data streams are defined, the catalog of scan engines may be created in block 310. Further, metadata for the particular scan engine may be created.

In some embodiments, the scan engine metadata may be stored in a separate metadata file from the catalog. Such embodiments may store the catalog in an XML or other file format, with individual XML files containing metadata for each scan engine.

The catalog and metadata may be distributed in block 312. The distribution mechanism may be any mechanism by which updates may be distributed. In some embodiments, a push mechanism may send updated catalog files to scan managers when updates are available, on a predefined schedule, or using some other trigger. In a pull mechanism, the scan mangers may periodically query a distribution server for any updates.

In some embodiments, the catalog and scan engine metadata may be distributed separately. In such an embodiment, the catalog may be distributed to multiple scan mangers, but the scan engine metadata may be available from a website or other remote server and individually downloaded. Such an embodiment may be useful when the scan engine metadata may be very large and only metadata for the desired scan engine metadata may be downloaded. In other embodiments where the scan engine metadata is not very large, the entire scan engine metadata may be downloaded in one file or may even be distributed with the catalog.

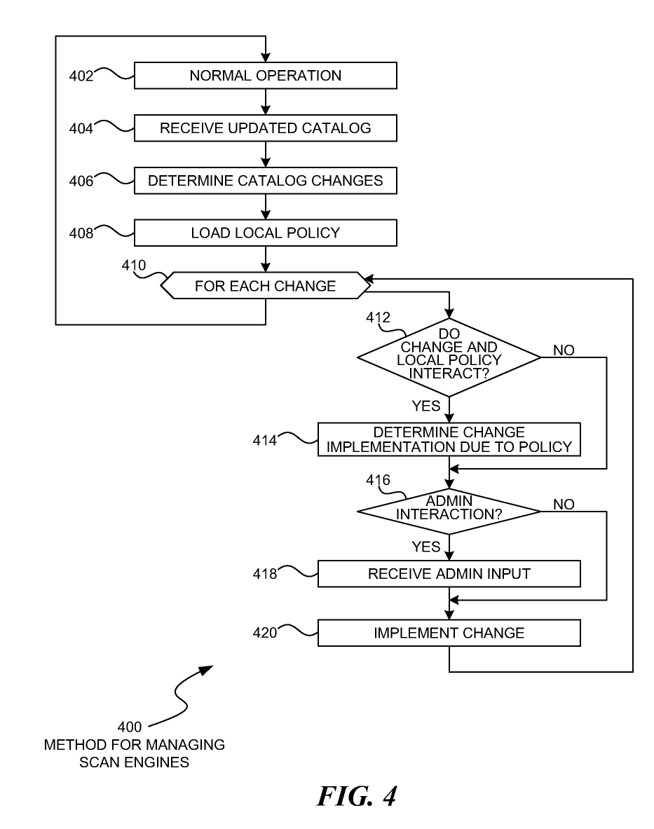

FIG. 4 is a flowchart illustration of an embodiment 400 showing a method for managing scan engines. Embodiment 400 is a method that may be performed by a scan manager, such as scan manager 102 and 204 as described in embodiments 100 and 200, respectively.

Other embodiments may use different sequencing, additional or fewer steps, and different nomenclature or terminology to accomplish similar functions. In some embodiments, various operations or set of operations may be performed in parallel with other operations, either in a synchronous or asynchronous manner The steps selected here were chosen to illustrate some principles of operations in a simplified form.

Embodiment 400 is an example of how a scan manager may update the scan engine configuration when an updated catalog is received. Embodiment 400 is an example of an automated process by which changes to the catalog may be implemented by upgrading or changing scan engines for various workloads.

In block 402, the scan manager may be in normal operation. In a normal operation, workloads may be processing various data streams, and the data streams may be being scanned by one or more scan engines.

In block 404, an updated catalog may be received and catalog changes may be determined in block 406. In some embodiments, a catalog updater or other process may compare an existing catalog with an updated catalog to identify changes. In other embodiments, the catalog may include indicators that highlight any changes. Some such embodiments may include a separate section within the catalog that identifies changes made within the catalog.

The local policy may be loaded in block 408. The local policy may define a desired type of scanning and various levels of scanning for the systems managed by the scan manager. The local policy may vary substantially between different instances of the scan manager and may define how a company or enterprise desires to have their scanning performed.

Each change to the catalog may be processed in block 410.

For an individual change, block 412 analyzes the change to determine if the change is affected by local policy. A change may be affected by local policy if the local policy defines any configuration options that may be applied to the changed scan engine. If such a change is to be evaluated in block 412, it may be determined in block 414. If the change is unaffected by the local policy, the process may continue to block 416.

In block 416, if administrator interaction is requests, the administrator input may be received in block 418. For example, a configuration may be approved by an administrator or certain settings may be selected by an administrator.

Once the settings are determined and any administrator input is received, the change may be implemented in block 420.

There may be several different methods by which a change may be made to a scan engine configuration. In a simple change, a setting or variable may be updated in a configuration file or other configuration mechanism. In more complex changes, an updated scan engine may replace an existing scan engine. Two different mechanisms for performing such an upgrade are presented in embodiments 500 and 600.

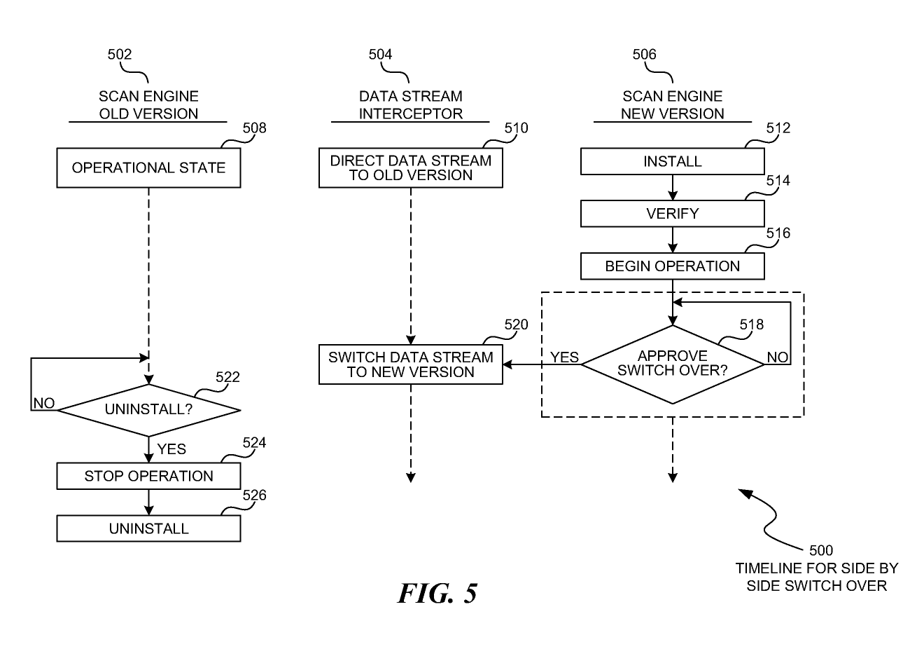

FIG. 5 is a timeline illustration of an embodiment 500 showing a method for a side-by-side switchover between scan engines. Embodiment 500 is a method that may be performed by a scan manager, such as scan manager 102 and 204 as described in embodiments 100 and 200, respectively.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 500 illustrates a mechanism by which a new version of a scan engine may be installed and made operational before switching a data stream from an existing scan engine to the new version of the scan engine. Embodiment 500 is a mechanism that may be used to switch between scan engines when the scan engines may be operational without interfering with each other.

Embodiment 500 shows the operations of several items in a timeline format. In the left column, an old scan engine 502 is shown. The center column shows a data stream interceptor 504, and the right column shows a new scan engine 506.

In some cases, the old scan engine 502 and new scan engine 506 may be different versions of the same scan engine, and may be capable of being installed and operational at the same time. In other cases, the old scan engine 502 and new scan engine 506 may be different scan engines from different scan engine suppliers, for example.

At the beginning of the timeline, the old scan engine 502 is shown in an operational state in block 508. During the same time, the data stream interceptor 504 is shown as directing a data stream to the old version in block 510. This situation may be the normal operational configuration of the scan engine and data stream.

While the normal configuration is operating, a new scan engine 506 may be installed in block 512 and verified in block 514. The new scan engine 506 may begin operation in block 516. While the new scan engine is installed and comes on line in blocks 512 through 516, the old scan engine 502 may be fully operational and may be performing scans for the data stream.

In block 518, an optional user interaction may occur. In block 518, an administrator may approve a switchover from the old scan engine 502 to the new scan engine 506, which may occur in block 520. In some embodiments, the switchover in block 520 may occur without user interaction or approval in block 518.

After the switchover occurs in block 520, the old scan engine 502 may be operational until a decision to uninstall may occur in block 522. The decision to uninstall may be delayed in situations where the old scan engine 502 may be used for multiple data streams or where an administrator wishes to keep the old scan engine available if a problem may occur with the new scan engine 506, for example.

Once the decision to uninstall is made in block 522, the old scan engine may be stopped in block 524 and uninstalled in block 526.

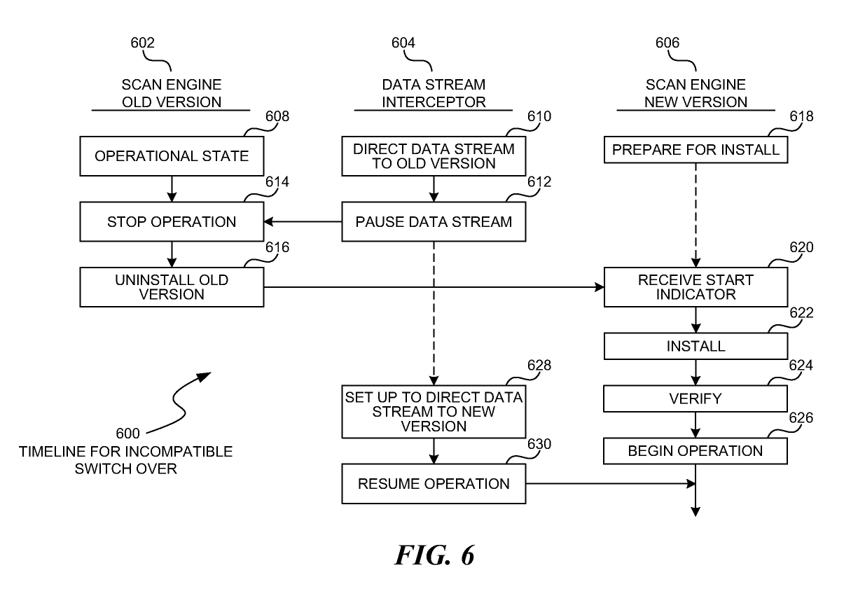

FIG. 6 is a timeline illustration of an embodiment 600 showing a method for upgrading an old scan engine with an incompatible new scan engine. Embodiment 600 is a method that may be performed by a scan manager, such as scan manager 102 and 204 as described in embodiments 100 and 200, respectively.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 600 illustrates a mechanism by which an old scan engine is removed before installing a new scan engine. Such a method may be considered a sequential switchover, as opposed to the side-by-side switchover presented in embodiment 500. While the process occurs, the data stream may be paused. Embodiment 600 is a mechanism that may be used to switch between scan engines when the scan engines interfere with each other during installation.

Embodiment 600 shows the operations of several items in a timeline format. In the left column, an old scan engine 602 is shown. The center column shows a data stream interceptor 604, and the right column shows a new scan engine 606.

In block 608, the old scan engine 602 may be in a normal operational state. While the old scan engine 602 is operating in block 608, the data stream interceptor 604 may be directing a data stream to the old scan engine in block 610.

While the normal operation is underway in blocks 608 and 610, the new scan engine 606 may be prepared for installation in block 618. Block 618 may contain preliminary operations that the new scan engine 606 may perform prior to installation.

In block 612, the data stream interceptor 604 may pause the data stream. Once the data stream is paused, the old scan engine 602 may stop operation in block 614 and uninstall in block 616. Once the uninstall is completed in block 616, the new scan engine 606 may receive a start indicator 620 that may cause the new scan engine to perform an installation in block 622 and verify the installation in block 624, then begin operation in block 626.

While the data stream is paused in block 612, the data stream interceptor 604 may change to direct the data stream to the new version in block 628. After the new scan engine 606 begins operation in block 626, the data stream interceptor 604 may resume operation in block 630 with the new scan engine 606 performing the scan for the data stream.

Embodiment 600 differs from embodiment 500 in that the data stream may be paused for an extended period of time during the uninstall operation of the old scan engine and installation of the new scan engine. This is in contrast with embodiment 500 where the data stream may be paused for a very short period of time and may even be capable of instantaneously switching from the old scan engine to the new scan engine.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A scan management system operable on a computer system comprising a processor, said scan management system comprising:
a data stream interceptor associated with a data stream within a workload, said data stream interceptor capable of passing contents of said data stream to a scan engine, said scan engines being capable of scanning said contents of said data stream;
a first catalog comprising metadata identifying a plurality of said scan engines and further identifying at least one data stream type to which said scan engine may be associated; and
a scan manager configured to receive a policy and said catalog and to determine configuration settings for each of said data stream interceptors, said configuration settings comprising assigning at least one of said scan engines to each of said data streams.

2. The scan management system of claim 1, said policy defining a first type of scan to be performed on a first type of data stream, said scan manager further configured to:
select a first scan engine corresponding to said first type of scan from said catalog;
select a first data stream corresponding to said first type of data stream; and
cause said first scan engine to receive contents from said first data stream.

3. The scan management system of claim 2, said scan manager further configured to:
receive an updated catalog;
determine differences between said first catalog and said updated catalog;
determine that said first scan engine is replaced by a second scan engine;
cause said second scan engine to receive contents from said first data stream; and
cause said first scan engine to not receive said contents when said second scan engine is receiving said contents.

4. The scan management system of claim 2, said scan manager further configured to:
receive an updated catalog;
determine differences between said first catalog and said updated catalog;
determine that said first scan engine is replaced by an updated version of said first scan engine in said updated catalog;
cause said updated version of said first scan engine to be installed;
cause said updated version of said first scan engine to receive contents from said first data stream; and
cause said first scan engine to not receive said contents when said second scan engine is receiving said contents.

5. The scan management system of claim 2, said first scan engine being further configured to receive contents from a second data stream.

6. The scan management system of claim 1, said policy defining a first type of scan to be performed on a first type of data stream, said scan manager further configured to:
select a first scan engine corresponding to said first type of scan from said catalog;
select a second scan engine corresponding to said first type of scan from said catalog;
select a first data stream corresponding to said first type of data stream; and
cause said first scan engine and said second scan engine to receive contents from said first data stream.

7. The scan management system of claim 6, said first scan engine and said second scan engine receiving said contents in serial.

8. The scan management system of claim 1, said policy defining a first type of scan to be performed on a first type of data stream, said scan manager further configured to:
select a first scan engine corresponding to said first type of scan from said catalog;
select a first data stream corresponding to said first type of data stream;
select a second data stream corresponding to said first type of data stream; and
cause said first scan engine to receive contents from said first data stream and said second data stream.

9. The scan management system of claim 8, said first data stream being associated with a first workload and said second data stream being associated with a second workload.

10. The scan management system of claim 8, said first data stream and said second data stream being associated with a first workload.

11. The scan management system of claim 1, at least one of said workloads being operable on said computer system.

12. The scan management system of claim 1, at least one of said workloads being operable on a second computer system.

13. The scan management system of claim 1, at least one of said scan engines being operable on said computer system.

14. The scan management system of claim 1, at least one of said scan engines being operable on a second computer system.

15. A method comprising:
receiving a catalog comprising metadata defining a plurality of scan engines, said metadata further comprising configurable parameters for at least some of said scan engines;
receiving a policy definition comprising a desired security level for a first type of data stream;
identifying a first data stream as being a first type of data stream;
selecting a first scan engine from said catalog as meeting said desired security level and being capable of scanning said first data type; and
configuring a data stream interceptor to pass contents from said first data stream to said first scan engine.

16. The method of claim 15 further comprising:
determining a configuration setting from said metadata to cause said first scan engine to operate in accordance with said desired security level; and
configuring said first scan engine with said configuration setting such that said first scan engine operates in accordance with said desired security level.

17. The method of claim 15, said catalog being received over a wide area network connection and said policy definition being received from a local source within a local area network.

18. A system comprising:
a processor;
a plurality of workloads, each of said workload comprising at least one data stream;
for each data stream, a data stream interceptor configured to capture contents from said data stream and transfer said contents to a scan engine;
a plurality of scan engines, each of said scan engines being capable of receiving content and performing a scan on said content;
a scan manager configured to:
receive a catalog comprising metadata defining a plurality of said scan engines, said metadata further comprising configurable parameters for at least some of said scan engines;
receive a policy definition comprising a desired security level for a first type of data stream;
identify a first data stream as being a first type of data stream;
select a first scan engine from said catalog as meeting said desired security level and being capable of scanning said first data type; and
configure a first data stream interceptor to pass contents from said first data stream to said first scan engine.

19. The system of claim 18, said first scan engine being configurable with at least one configuration setting.

20. The system of claim 18, said first data stream being associated with a first workload, said first workload being configurable with at least one configuration setting by said scan manager.
